(19) United States
(12) Patent Application Publication
(10) Pub. No.: US 2022/0136608 A1
(43) Pub. Date: May 5, 2022

(54) VALVE DEVICE FOR SHUTTING OFF OR CONTROLLING A FLOW OF A FLUID

(71) Applicant: ILLINOIS TOOL WORKS INC., Glenview, IL (US)

(72) Inventor: Carsten HELDBERG, Kirchlinteln (DE)

(21) Appl. No.: 17/507,171

(22) Filed: Oct. 21, 2021

(30) Foreign Application Priority Data
Oct. 30, 2020 (DE) 10 2020 128 600.7

(51) Int. Cl. F16K 1/38; F16K 37/00; F16K 1/42

(52) U.S. Cl. CPC F16K 1/38; F16K 1/42; F16K 37/0033

(57) ABSTRACT

A thermostat valve for shutting off and/or controlling a flow of a fluid includes a housing device with a valve passage opening which, in a throughflow direction, has at least one approximately cylindrical passage section and one passage sealing section. The passage sealing section has a larger diameter than the passage section. A closure element for closing off the valve passage opening has at least one approximately cylindrical closure section, which can be arranged in the region of the cylindrical passage section, and one closure sealing section, wherein the closure sealing section has a larger diameter than the cylindrical passage section. An annular gap with an approximately constant opening cross-section is provided between the passage section and the closure section. The annular gap is formed such that, when the valve apparatus is opened, the opening cross-section is constant over a predetermined valve stroke of the closure element.

### TECHNICAL FIELD

The present invention relates to a valve apparatus, in particular a thermostat valve, for shutting off and/or controlling a throughflow of a fluid.

### BACKGROUND

In valves in the narrower sense, a closure part (e.g. plate, cone, ball, or needle) is moved approximately parallel to the direction of flow of the fluid. The flow is interrupted in that the closure part is pressed with the sealing surface to a suitably shaped opening, the valve or sealing seat.

The change in the flow rate typically shows approximately linear behavior across the entire range of the valves. Thus, in addition to blocking material flows, valves are well-suited for control tasks.

A thermostat valve is a temperature controller that controls the flow rate as a function of the measured temperature in order to keep the set temperature constant.

The sensor and the actuation of the valve can be embodied by a single element (e.g. an expansion vessel) or by various components, or can also be structurally directly connected to the valve.

A thermostat valve is a temperature controller that controls the flow rate as a function of the measured temperature in order to keep the set temperature constant.

A thermostat or thermostat valve is an important component of liquid cooling. It has the task of ensuring that an internal combustion engine reaches its optimum operating temperature as quickly as possible and then maintains it under all operating conditions. This is an important precondition for the internal combustion engine to be able to operate optimally under all load conditions and to produce low pollutant levels.

As a function of the type of use and technology of the internal combustion engine, thermostats must have different characteristics and functions.

Insert thermostats (wax thermostats) are individual components positioned inside a housing. They control coolant temperature accurately, are robust, maintenance-free, and have proven themselves for decades. Housing thermostats (wax thermostats) consist of the insert and the housing. These modules are fully integrated into the engine.

The heart of the wax thermostat is the work element. This is a compression-resistant housing. It is filled with a special wax. After starting the engine, the cooling liquid heats the work element. As of a predetermined temperature, the wax in the work element liquefies. In doing so, the wax expands and pushes in the housing onto a pin that serves as the work piston.

The work piston is now forced out of the housing and opens the coolant flow to the radiator via a poppet valve. This keeps the engine in the optimum temperature range. If the coolant drops below the predetermined opening temperature again, the poppet and pin are pushed by a spring back into the home position. This discontinues the coolant flow to the radiator.

Power-optimized modern cars require thermostats with a wider working range than the conventional wax thermostat for the cooling capacity of the internal combustion engine. In order to meet these requirements, electrically heated thermostats (map-controlled thermostats) have been developed. By the additional control via engine management, the engine temperature can be adjusted more precisely and as needed. The advantages: better consumption values and lower pollutant emissions.

The electrically heated thermostat works as follows: The wax is heated in the work element by the coolant and an electric heater. As a result of this combination, the engine temperature can be individually controlled as a function of the load requirement. The electric heating of the work element is controlled by the electronic engine management based on various parameters. In situations with greatly increased power requirements, the heater also causes the coolant circuit to open up early.

By permanently controlling the thermostat, the engine is always kept within an optimal temperature range. In this range, the best possible combustion of the fuel air mixture occurs. This reduces fuel consumption and creates low pollutant emissions, ultimately conserving resources and the environment.

EP 0 900 329 B1 describes a uniform solenoid-actuated fluid flow control valve apparatus.

Furthermore, DE 40 39 351 A1 discloses the monitoring of the position of a valve apparatus via a position sensor, which can be an ohmic (potentiometer) or inductive (magnetic anchor) or magnetostrictive (magnetic field) or capacitive (polarization) sensor type.

### SUMMARY

The problem addressed by the present invention is to provide an alternative to the valve apparatuses, in particular thermostat valves, known from the prior art. Another problem addressed by the present invention is to provide a valve apparatus that is safe and reliable in operation.

Furthermore, a problem addressed by the present invention is to provide a valve apparatus, in particular a thermostat valve, in which an opening state is safely and reliably detectable despite existing tolerances.

In addition, the valve apparatus is to provide an alternative to wax thermostats and map-controlled thermostats

One or more of these problems are addressed by the features of independent claim 1. Advantageous configurations are specified in the respective dependent subclaims.

According to the invention, a valve apparatus, in particular a thermostat valve, for shutting off and/or controlling a throughflow of a fluid is provided. Said valve apparatus comprises a housing device with a valve passage opening which, in a throughflow direction, has at least one approximately cylindrical passage section and one passage sealing section, wherein the passage sealing section has a larger diameter than the passage section, and a closure element for closing off the valve passage opening, said closure element having at least one approximately cylindrical closure section, which can be arranged in the region of the cylindrical passage section, and one closure sealing section, which can be arranged in the region of the passage sealing section, wherein the closure sealing section has a larger diameter than the cylindrical passage section, and wherein an annular gap with an approximately constant opening cross-section is provided between the passage section and the closure section, wherein the annular gap is formed in such a way that, when the valve apparatus is opened, the opening cross-section is constant over a predetermined valve stroke of the closure element.

Valve apparatuses have certain tolerances on the basis of their construction and manufacturing. A corresponding closure element along with the sealing device can, for example, tilt or twist. Corresponding sensor boards are usually arranged outside of the valve, and a corresponding detection of the valve position must take place through a wall of the component. Also, manufacturing tolerances can occur in a magnet of the valve apparatus, such that field strength changes with temperature.

For so-called On-Board Diagnostics (OBD), it is important whether a valve apparatus, in particular a thermostat valve, is properly closed. A stopper is usually provided for this purpose, and once this stopper is reached by the closure element, a corresponding switch signal is transmitted to a controller or a control device to the effect that the valve apparatus is closed.

With the present invention, an alternative valve apparatus is provided that can detect a closed opening state when the working stroke is approximately 0.4 mm to 0.6 mm, and preferably approximately 0.5 mm, and with which an open opening state is detected when the working stroke is greater than 0.6 to approximately 0.8 mm, and preferably approximately greater than 0.75 mm.

With the present invention, an alternative valve apparatus is provided, with which a maximum opening cross-section of preferably 3% is safely and reliably detectable and, in particular, the above-mentioned tolerances are compensable.

According to the invention, this is made possible in that an annular gap with an approximately constant opening cross-section is provided between the passage section and the closure section, wherein the annular gap is formed in such a way that, when the valve apparatus is opened, the opening cross-section is constant over a predetermined valve stroke of the closure element. By contrast, it is provided in valve apparatuses known from the prior art that an opening cross-section opens up exponentially or approximately linearly when the closure element moves.

By contrast, it is provided in the present invention that the opening cross-section is constant over a predetermined valve stroke of the closure element.

With such a valve apparatus, it is important to achieve a very flat characteristic curve (very low flow rate) when opening the valve apparatus, wherein the flow rate is then to increase more sharply upon a further opening of the valve apparatus. This is particularly important during a cold start (beginning of the opening of the valve apparatus), because very cold coolant is often removed from the cooling system and even small flow rates are sufficient for temperature adjustment, in particular of an engine. In a normal control operation, the coolant removed from a radiator is significantly warmer, and a significantly greater flow rate is required in order to adjust the engine temperature.

The predetermined valve stroke over which the opening cross-section is constant can preferably be approximately 0.8 mm to 2.5 mm, or approximately 2 mm, or approximately 1.5 mm, and preferably approximately 1 mm.

According to the present invention, it is thus provided that, with the annular gap, only a constant cross-section of the valve passage opening is opened over a valve or working stroke of 1 mm. The present invention is therefore characterized in that an area with a nearly constant opening cross-section is additionally provided in the actual valve apparatus or in a thermostat valve.

The annular gap can open up approximately 1% to approximately 5%, or to approximately 4%, or to approximately 3%, and preferably approximately 2% of the opening cross-section of the valve passage opening.

In this way, a cylindrical area having a height of approximately 1 mm is provided, which opens up an annular gap with approximately 2% opening cross-section over the working stroke of approximately 1 mm and only increases the cross-section proportionally to the valve stroke with larger strokes.

According to the invention, a proportional increase of the cross-section to the valve stroke can then be achieved by conically flaring or concavely forming the passage sealing section of the housing device and thus the closure sealing section of the closure element in the throughflow direction. Preferably, the closure sealing section is configured to correspond to the passage sealing section.

In addition, a sensor device can be provided for detecting an opening state of the valve apparatus. The sensor device can have a mechanical or programmable Hall sensor and a magnet.

The magnet can be disposed perpendicularly on a wall of the closure section or a closure section of the closure element facing opposite the throughflow direction, wherein the Hall sensor is disposed approximately orthogonally to the magnetic field lines of the magnet.

The Hall sensor can be configured such that a closed opening state is detected when the working stroke amounts to approximately 0.4 mm to 0.6 mm, preferably approximately 0.5 mm.

A closed opening state can be detected, for example, when less than 3% of the opening cross-section is opened up by the closure element.

The Hall sensor can be configured such that an open opening state is detected when the working stroke amounts to more than 0.6 mm to approximately 0.8 mm, preferably approximately more than 0.75 mm.

An open opening state can be detected, for example, when more than 3% of the opening cross-section is opened up by the closure element.

The sensor device is thus provided for detecting an open or closed opening state of the valve apparatus, in particular a thermostat valve.

This results in the following switch points. A “signal closed” occurs when the working stroke is approximately 0.5 mm (e.g. when an opened up valve cross-section is less than 3% of a full opening of the valve apparatus). A “signal open” occurs when the working stroke is approximately greater than 0.75 mm (e.g. when the valve cross-section is greater than 3% of the full opening).

The typical working strokes of expansion element/thermostat valves result in a switch point hysteresis of approximately 0.3 mm from the cross-sectional specifications.

In order to achieve a good repeatability of the switch point in the entire temperature range, the magnet can be disposed perpendicularly on a wall of the closure section, in particular a valve plate, of the closure element, facing opposite to the throughflow direction. Thus, the magnet is disposed at a right angle to a Hall sensor surface of the Hall sensor.

Preferably, the magnet can face in the throughflow direction with the active pole, according to the present invention the south pole.

In this way, the Hall sensor is disposed in the area of near vertical field lines of the magnet.

The switch point, which indicates the closed switch state, in the present case in the area of the higher field strength by the active pole of the magnet, can be defined or formed very precisely by a mechanical stopper of the valve.

A movement of the valve device in the throughflow direction then leads to a sharp decrease in the active field strength. This is nearly in the vertical area of the field lines of the magnet. A low switching hysteresis is thus achieved.

The field strength of the magnet also changes a little over a larger temperature range.

The magnet is preferably formed from a magnetic material, for example SmCo. This allows for a relatively small change in field strength over a larger temperature range. However, the switch points still shift with the temperature, so that the desired requirements cannot be safely met.

In order to comply with these requirements and to safely and reliably detect a closed switch state, the area according to the invention with a nearly constant opening cross-section is provided in the valve apparatus. As already explained above, this is a cylindrical area having a height of approximately 1 mm, which opens up an annular gap with an approximately 2% opening cross-section over the working stroke of approximately 1 mm and only increases the cross-section proportionally to the valve stroke with larger strokes.

### BRIEF DESCRIPTION OF THE DRAWINGS

The present invention is described in more detail in the following on the basis of an exemplary embodiment and corresponding characteristic curves as shown in the figures. The figures show:

FIG. 1 is a schematic partial view of a valve apparatus according to the invention,

FIG. 2 is a schematic view of the arrangement of a sensor device of the valve apparatus,

FIGS. 3 and 4 are diagrams representing switch points of the valve apparatus.

### DETAILED DESCRIPTION

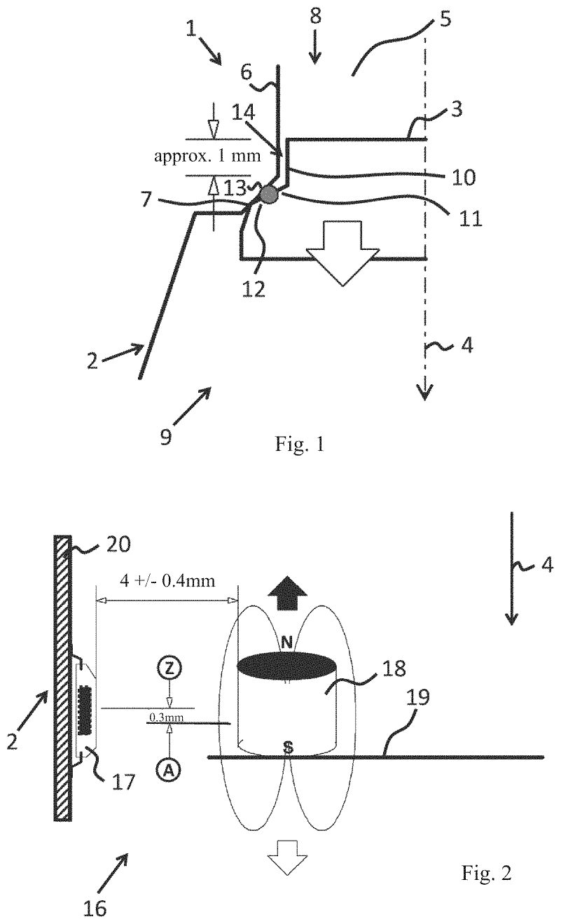

The following describes a valve apparatus 1 according to the invention, in particular a thermostat valve, for shutting off or controlling a throughflow of a fluid (FIGS. 1 and 2).

The thermostat valve 1 is a component part of a cooling circuit of a motor vehicle. It is configured such that an internal combustion engine reaches its optimum operating temperature as quickly as possible and subsequently maintains it under all operating conditions.

The valve apparatus 1 comprises a housing device 2 and a closure element 3.

The housing device 2 is configured as a rotationally symmetric body and limits a valve passage opening 5 extending in a throughflow direction 4.

In the throughflow direction 4, the valve passage opening 5 has a roughly cylindrical passage section 6 and a passage sealing section 7.

The passage sealing section 7 has a larger diameter than the passage section 6 and is designed in order to widen conically in the throughflow direction 4, i.e. the passage sealing section 7 is designed to be conical in cross-section.

The valve apparatus 1 is thus a passage valve, wherein a fluid inlet 8 and a fluid outlet 9 are parallel to the throughflow direction 4 and the direction of flow, respectively.

The closure element 3 for closing the valve passage opening forms a shut-off body of the valve apparatus. The closure element 3 comprises an approximately cylindrical closure section 10, which can be disposed in the area of the cylindrical passage section 6, and a closure sealing section 11, which can be disposed in the area of the passage sealing section 7.

The closure section 10 is cylindrical in shape corresponding to the passage section 6. The closure section 10 has at least one cylindrical section with a length of at least 1 mm in the throughflow direction 4.

The closure sealing section 11 is configured in order to approximately correspond to the shape of the passage sealing section 7. It thus has a larger diameter than the closure section 10 and is designed in order to flare conically in the throughflow direction 4. This means that the closure sealing section 11 is approximately conical in cross-section. Alternatively, a convex shape in cross-section can also be provided here.

In order to seal the valve apparatus 1, the closure sealing section 11 of the closure element 3 comprises a radially circumferential recess 12 for receiving a sealing element 13. The sealing element 13 can be an O-ring seal, for example.

Alternatively, the sealing element can also be arranged accordingly in the passage section 7.

An annular gap 14 with an approximately constant opening cross-section 15 is provided between the passage section 6 and the closure section 10. The annular gap 14 is configured such that the opening cross-section is constant when the valve apparatus is opened over a predetermined valve stroke of the closure element 3.

Furthermore, the valve apparatus according to the invention comprises a sensor device 16 (FIG. 2). The sensor device 16 has a mechanical or programmable Hall sensor 17 and a magnet 18.

The magnet 18 is disposed on a wall 19 of the closure section 10 of the closure element 3, which is transverse to the throughflow direction 4 and faces opposite the throughflow direction 4. This wall 19 forms a valve plate. Accordingly, the valve apparatus according to the present invention can be considered a poppet valve.

The Hall sensor 17 is disposed approximately orthogonally to the magnet 18 on a housing wall 20 of the housing device 2 that limits the valve passage opening 5.

A distance between the Hall sensor 17 and the magnet 18 is approximately 4 mm +/−0.4 mm (FIG. 2).

In a state of “valve closed,” an actual voltage of approximately 0.5 V is provided (FIG. 2). In a state of “valve open,” an actual voltage of approximately 4.5 V is provided.

Furthermore, in FIG. 2, the magnet 18 is shown, wherein the north pole is disposed at the top and the south pole is disposed at the bottom, wherein the north pole and the south pole represent the two different poles of a permanent magnet. The magnetic field proceeds from the north pole and runs to the south pole as shown via the field lines. Inside the magnet, the field lines then close again.

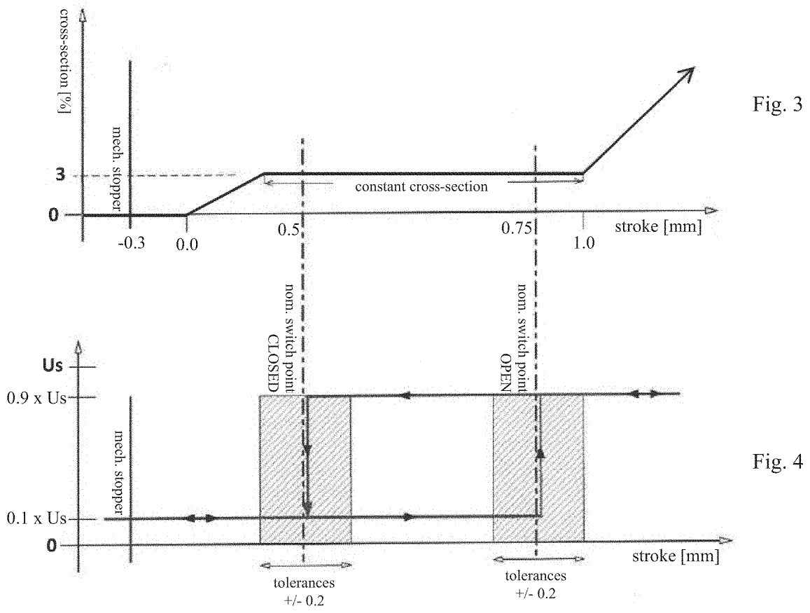

The diagrams in FIGS. 3 and 4 show the switch points of a closed opening position (switch point closed) and an open opening position (switch point open).

In the diagram in FIG. 3, the valve stroke of the closure element 3 is indicated on the x-coordinate. The corresponding y-coordinate indicates the opening cross-section as a percentage.

A mechanical stopper is provided for a valve stroke of −0.3 mm (represented by the vertical line at −0.3 mm). The vertical dashed lines at 0.5 mm of the working stroke describes a nominal switching point CLOSED. The vertical dashed lines at 0.75 mm of the working stroke describes a nominal switch point OPEN.

The horizontal portion of the graph in FIG. 3 shows the constant opening cross-section.

The rectangles in FIG. 4 represent a tolerance of +/−0.2 mm.

The Hall sensor 17 is configured in order to detect a closed opening state when the working stroke is approximately 1 mm, 0.9 mm, 0.8 mm, 0.7 mm, or 0.6 mm to 0.4 mm, or to 0.3 mm, or to 0.2 mm, or to 0.1 mm, or to 0 mm, and preferably approximately 0.5 mm. Furthermore, the Hall sensor 17 is configured in order to detect an open opening state when the working stroke is approximately greater than 0.5 mm, 0.6 mm, or 0.7 mm, to approximately 0.8 mm, or to 0.9 mm, or to 1 mm, or to 1.1 mm, or to 1.2 mm, or to 1.3 mm, or to 1.4 mm, or to 1.5 mm, and preferably approximately greater than 0.75 mm.

In the context of the disclosure of the present invention, the opening cross-section defines a maximum flow rate (opening cross-section 100%) that can pass through the passage opening 5 in the throughflow direction 4. This means that, with an opening cross-section of 100%, a maximum flow rate in the throughflow direction 4 passes through the passage opening 5 of the valve apparatus 1.

At a stroke of −0.3 mm, a mechanical stopper of the valve apparatus 1 is provided, which is achieved when the sealing element 13 is completely compressed against the passage sealing section 7 of the housing device 2 by the closure sealing section 11 of the closure element 3.

At a valve stroke of 0 mm, the sealing element 13 contacts the closure sealing section 11 unpressurized.

In the diagram in FIG. 4, the x-coordinate again denotes the valve stroke. The switching voltage Us for sensing the corresponding switch points of the Hall sensor is indicated on the y-coordinate.

According to the characteristic curves shown in FIGS. 3 and 4, a valve apparatus according to the invention is considered to be closed when opening up to a valve stroke of 0.75 mm.

When closing, the switch point of the closed opening position is reached at a valve stroke of 0.5 mm.

In the range of a valve stroke of 0 mm—or in a home position in which the valve sealing section 11 precisely contacts the sealing element 13, or along with the sealing element 13 the passage sealing section—up to a valve stroke of 1 mm, the cylindrical area having a height of approximately 1 mm is provided between the passage section 6 of the valve passage opening 5 and the closure section 10 of the closure element. A annular gap with an approximately 2% opening cross-section is then opened up.

Only in case of larger strokes does the cross-section of the valve passage opening or the opening cross-section increase proportionally to the valve stroke. This can be seen in FIG. 3 at a stroke of 1 mm, because the cross-section marked on the y-coordinate increases proportionally over the valve stroke.

### LIST OF REFERENCE NUMERALS

1 Valve apparatus

2 Housing device

3 Closure element

4 Throughflow direction

5 Valve passage opening

6 Passage section

7 Passage sealing section

8 Fluid inlet

9 Fluid outlet

10 Closure section

11 Closure sealing section

12 Recess

13 Sealing element

14 Annular gap

15 Opening cross-section

16 Sensor device

17 Hall sensor

18 Magnet

19 Wall

20 Housing wall

1. A valve apparatus for shutting off and/or controlling a throughflow of a fluid, comprising
a housing device with a valve passage opening which, in a throughflow direction, has at least one approximately cylindrical passage section and one passage sealing section, wherein the passage sealing section has a larger diameter than the passage section, and
a closure element for closing off the valve passage opening, said closure element having at least one approximately cylindrical closure section, which can be arranged in the region of the cylindrical passage section, and one closure sealing section, which can be arranged in the region of the passage sealing section, wherein the closure sealing section has a larger diameter than the cylindrical passage section, and
wherein an annular gap with an approximately constant opening cross-section is provided between the passage section and the closure section, wherein the annular gap is formed in such a way that, when the valve apparatus is opened, the opening cross-section is constant over a predetermined valve stroke of the closure element

2. The valve apparatus as claimed in claim 1,
wherein
the annular gap opens up approximately 2% of the opening cross-section.

3. The valve apparatus as claimed in claim 1,
wherein
the predetermined working stroke over which the opening cross-section is constant amounts to approximately 1 mm

4. The valve apparatus as claimed in claim 1,
wherein
a sensor device for detecting an opening state of the valve apparatus is provided.

5. The valve apparatus as claimed in claim 4,
wherein
the sensor device has a mechanical or a programmable Hall sensor and a magnet, wherein the magnet is arranged perpendicularly on a wall, facing in the direction counter to the throughflow direction, of the closure section of the closure element, and the Hall sensor is arranged approximately orthogonally to the magnetic field lines of the magnet.

6. The valve apparatus as claimed in claim 5,
wherein
the Hall sensor is designed in such a way that
a closed opening state is detected when the working stroke amounts to approximately 0.4 mm to 0.6 mm, preferably approximately 0.5 mm, and that
an open opening state is detected when the working stroke amounts to greater than 0.6 mm to approximately 0.8 mm, preferably approximately greater than 0.75 mm.

7. The valve apparatus as claimed in claim 1,
wherein
the passage sealing section, in the throughflow direction, is of approximately conically widening or concave form, wherein the closure sealing section is formed in a manner corresponding to the passage closure section.

8. The valve apparatus as claimed in claim 1,
wherein
the valve apparatus is a thermostat valve.
